(19) United States
(12) Patent Application Publication
(10) Pub. No.: US 2005/0098525 A1
(43) Pub. Date: May 12, 2005

(54) Transport apparatus for removal of bobbins

(75) Inventors: Bernd Keen, Nordhorn (DE); Jorg Wolf, Neuenhaus (DE)

Correspondence Address: HENRY M FEIEREISEN, LLC, 350 FIFTH AVENUE, SUITE 4714, NEW YORK, NY, 10118, US

(73) Assignee: NEUENHAUSER MASCHINENBAU GMBH, Neuenhaus (DE)

(21) Appl. No.: 10/960,765

(22) Filed: Oct. 7, 2004

(30) Foreign Application Priority Data
Oct. 8, 2003 (DE) 203 15 646.3

(51) Int. Cl. B66C 19/00

(52) U.S. Cl. 212/332

(57) ABSTRACT

Apparatus for removing a bobbin deposited by a bobbin winding device includes a traveling unit suspended from an overhead track and having a drive comprised of an electric motor and a driving roller rolling along the track. A gripping device has at least two gripper arms for grabbing a bobbin in a jaw-like manner, whereby the gripper arms are urged by a mechanical spring assembly against a bobbin surface and can be released from the bobbin surface through pneumatic or electric energy in opposition to the spring assembly. A motor-driven hoisting device connects the gripping device to the traveling unit and moves the gripping device between up and down positions, wherein the gripping device is centered in the traveling unit, when assuming the up position. Flexible supply lines are provided to feed power to the traveling unit and the gripping device and extend between one end of the track and a connection of the traveling unit.

### CROSS-REFERENCES TO RELATED APPLICATIONS

This application claims the priority of German Patent Application, Serial No. 203 15 646.3, filed Oct. 8, 2003, pursuant to 35 U.S.C. 119(a)-(d), the disclosure of which is incorporated herein by reference.

### BACKGROUND OF THE INVENTION

The present invention relates to a transport apparatus for removal of bobbins deposited by a bobbin winding device.

Nothing in the following discussion of the state of the art is to be construed as an admission of prior art.

European Pat. No. EP 0 620 145 describes an apparatus for conveying bobbins, having a track and a traveling unit suspended from the track for picking up bobbins and moving them along longer, partly branched traveling paths. The traveling unit is connected to a gripping device via belts which are motor-driven for up and down movement. The gripping device includes a gripper frame and gripper arms which can bear upon the curved surface of a bobbin like jaws. The track for the traveling unit is constructed in accordance with VDI (Association of German Engineers) guidelines 36 43/C1 as running rail for electric overhead conveyor. The traveling unit is then configured to match the rail configuration. The gripping device includes several pairs of gripper arms in the form of a parallelogram which move by using pneumatic energy. Each bobbin is grasped by a pair of gripper arms, and the force for grasping a bobbin is hereby adjusted in dependence on the bobbin density by a valve which regulates the air pressure on the gripping device. Pneumatic energy is provided by a pressure container which is connected to the gripping device by helicoidal compressed air hoses. The belts positioned on the end surfaces of the gripper frame are guided in opposite directions via a winding drum which is operated by an electric motor.

When arranging winding devices in a row for winding extruded chemical fibers, an operator is unable to freely move in front of the winding devices.

It would therefore be desirable and advantageous to provide an improved transport apparatus for removal of bobbins which obviates prior art shortcomings and which is simple in structure and yet reliable in operation without interfering with activities by an operator.

### SUMMARY OF THE INVENTION

According to one aspect of the present invention, an apparatus for removing a bobbin deposited by a bobbin winding device, includes a track extending anteriorly of a plurality of bobbin winding devices, a traveling unit suspended from the track and movable along the track in a travel direction, wherein the traveling unit includes a drive comprised of an electric motor and one driving roller rolling along the track at least indirectly, a gripping device having a gripper frame, at least two gripper arms connected to the frame for grabbing a bobbin in a jaw-like manner, a mechanical spring assembly for urging the gripper arms against a surface of the bobbin, with the apparatus further including a release mechanism operable to release the gripper arms from the surface of the bobbin, a motor-driven hoisting device connecting the gripping device of the traveling unit and constructed to move the gripping device between an up position and a down position, wherein the gripping device is centered in the traveling unit, when assuming the up position, and flexible supply lines feeding power to the traveling unit and the gripping device and extending between one end of the track and a connection of the traveling unit.

The present invention resolves prior art problems by constructing the traveling unit as self-propelling trolley having an electric motor which is driven by a driving roller for travel along the track. The motive drive may be configured in the form of a friction drive. Currently preferred is the construction of the motive drive with a toothed belt which extends along the track and meshes with a driving roller in the form of a toothed roller. Suitably, the toothed belt is securely mounted along the track and constructed to describe an omega-shaped loop which moves with the traveling unit, with the toothed roller engaging the toothed belt in a form-fitting or force-locking manner. The omega-shaped loop of the toothed belt is formed by the driving roller and two deflection rollers on the traveling unit. The toothed roller meshes with the toothed belt effectively without slippage and ensures a reliable positioning of the traveling unit at each location of the track.

Advantageously, the gripper arms of the gripping device are urged by the mechanical spring assembly against the surface of a bobbin. The gripper arms are able to grasp a bobbin at the end surfaces. Suitably, the bobbin surface has a convex curvature to ensure a continuous clamping contact between the gripper arms and a bobbin. Release of the gripper arms from a bobbin can be realized by applying pneumatic or electric energy, with the gripping device correspondingly constructed to ensure the detachment of the gripper arms from the bobbin surface. In the absence of this energy, the gripper arms are automatically forced into the clamping position by the mechanical spring assembly.

The transport of bobbins is executed only when the gripping device occupies the up position. Suitably, the hoisting device, which is connected to the traveling unit, includes several hoisting members which may be flexibly constructed for adjustment of a distance to the bobbin surface so that the bobbins to be transported are securely held in place.

As the traveling unit is self-propelled, the flexible supply lines for feeding the electric and/or pneumatic energy for the traveling unit and the gripping device, respectively, can extend from one end of the track, e.g. from a control and regulating unit, whereby the other ends of the supply lines may then advantageously be attached to the connection on the traveling unit. Of course, a direct connection to a consumer may also be conceivable. In this way, the traveling unit can move without any problem along the entire traveling route as defined by the track.

Although the transfer of bobbins from one winding device to a further transport device may be controlled by hand, it is currently preferred to integrate the transfer process in a stored-program control which initiates the transport in dependence on the bobbins readied by the winding devices.

According to another feature of the present invention, the track may be realized by two rails which are constructed of C-shaped cross section and open downwardly for guiding the traveling unit. The rails can be adjustably mounted to a carrier frame, whereby the traveling unit includes track rollers, which rotate about horizontal axes, and support rollers, which rotate about vertical axes in one of the rails.

According to another feature of the present invention, the hoisting device may include at least two hoisting members, with the supply lines for feeding power to the gripping device extending in the form of a helix between the traveling unit and the gripper frame and between the two hoisting members. As a result, the supply lines are thus protected in any height position of the gripping device between the hoisting members while ensuring their supply function at any time.

According to another feature of the present invention, the hoisting members may each be constructed in the form of a flat belt having broad sides defining planes which extend transversely to the travel direction of the traveling unit. As a result of the greater width in relation to their thickness and the disposition of the broad sides in transverse relation to the travel direction of the traveling unit, vibrations transversely to the travel direction are minimized. The flat belts may be made of plastic or textile material or fiber combinations of plastic and textile. Although currently less preferred, it is, of course feasibly, to use ropes or chains as hoisting members.

According to another feature of the present invention, the release mechanism may be constructed as a pneumatic cylinder for detaching the gripper arms from the bobbin. The pneumatic cylinder may be embedded in the gripper frame and communicate via a helicoidal supply line between the hoisting members with the traveling unit and the provided connection. As an alternative to the arrangement of a pneumatic cylinder, it is also possible to provide an electrically operated linear drive of any configuration to realize the detachment of the gripper arms from a bobbin.

According to another feature of the present invention, the gripper arms may have an arcuate flat configuration, with the gripping device having adjustment bars for connection to the gripper arms in one-to-one correspondence, wherein the adjustment bars are operatively connected to guide rollers, at least indirectly, for horizontal movement and engagement in a vertically adjustable forced guidance, which is acted upon by the spring assembly in upward direction. The mechanical spring assembly may be constructed to include helical compression springs disposed in tetragonal configuration. The arcuate configuration of the gripper arms conforms hereby to the convex surface structure of the bobbins, whereby the flat configuration enhances torsion stiffness. The downward movement of the forced guidance can be implemented by a pneumatic cylinder or electric linear drive. For that purpose, the piston rod of the pneumatic cylinder having a housing for securement to the gripper frame, or the adjustment rod of the linear drive are coupled to the guidance.

According to another feature of the present invention, the gripper arms may be so constructed as to be pivotable in several positions. In this way, the gripper arms can easily be matched to different bobbin diameters by accordingly adjusting the radial deflection of the gripper arms.

According to another feature of the present invention, each gripper arm has a free lower end which may have attached thereto a switching strip including an electric sensor and air compartments which are sealed off to the outside. The switching strip becomes operational as soon as a contact, for example with an operator, is registered to trigger an immediate movement of the gripping device to the up position into the traveling unit. The risk of damage to the gripping device or accidents of the operator can thus be effectively eliminated. An alternative protection feature may include the provision of electronic bumpers along the free lower ends of the gripper arms.

When the gripping device includes at least two hoisting members in the form of flat belts, it is suitable to secure the lower ends of the belts laterally to the gripper frame. Of course, it also possible to secure further hoisting members to an end surface of the gripper frame.

According to another feature of the present invention, the flat belts may interact with winding drums in one-to-one correspondence, with the traveling unit including an electric motor for synchronous operation of the winding drums. Such a synchronous drive may be realized by the use of toothed belts and respective toothed rollers to ensure a slip-free transfer of the drive energy.

According to another feature of the present invention, the gripper frame may include an upwardly extending centering mandrel which is received in a sleeve of the traveling unit. In this way, the gripping device can be securely and reliably held in the elevated position within the traveling unit.

According to another feature of the present invention, an energy chain of plates may be provided to extend next to the track to form a kind of crawler, with the supply lines for feeding electric and/or pneumatic power to the traveling unit being embedded in the energy chain. As a result, the energy chain secures the position of the supply lines and protects them against damage from external impacts. Suitably, the energy chain is received in an upwardly open U-shaped trough which extends next to a rail of the track.

According to another feature of the present invention, a dome may be provided for enveloping the traveling unit, whereby the dome has a downwardly open concave opening for receiving the gripping device. The dome thus protects each transported bobbin against external impacts.

According to another feature of the present invention, a protective guard may be associated to the traveling unit and disposed for movement below the gripping device. The protective guard represents a further safety element to catch bobbins and protect them from falling down in the event of malfunction of the gripper arms. The protective guard may be swingably or movably constructed.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of a transport apparatus for removing bobbins deposited by a winding device, embodying the subject matter according to the present invention;

FIG. 2a is an enlarged cutaway view of the transport apparatus of FIG. 1, as viewed in the direction of arrow 11, showing a gripping device of the transport apparatus in an up position;

FIG. 2b is a schematic illustration of the gripping device in a down position;

FIG. 3 is a schematic illustration, on a still enlarged scale, of the transport apparatus, with the gripping device in the up position for removal of bobbins;

FIG. 4 is a schematic illustration, on an enlarged scale, of the gripping device in the down position;

FIG. 5 is a partly sectional view of the transport apparatus, taken along the line V-V in FIG. 3 and viewed in the direction of arrow Va; and

FIG. 6 is a plan view of the transport apparatus in the direction of arrow VI in FIG. 5.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

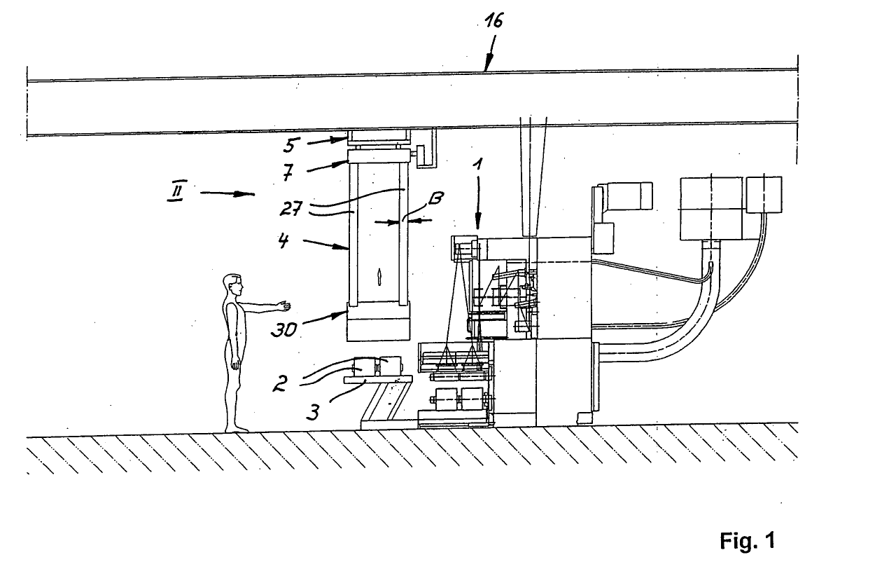

Turning now to the drawing, and in particular to FIG. 1, there is shown a schematic side view of a transport apparatus, generally designated by reference numeral 4, for removing bobbins 2 deposited by a winding device, generally designated by reference numeral 1 and constructed to wind extruded chemical fibers. Although not shown in the drawing, a plurality of such winding device 1 are disposed next to one another in a row. Bobbins 2 wound by a winding device 1 are deposited by the winding device on a table 3 for pickup by the transport apparatus 4 for transfer to a continuing transport unit.

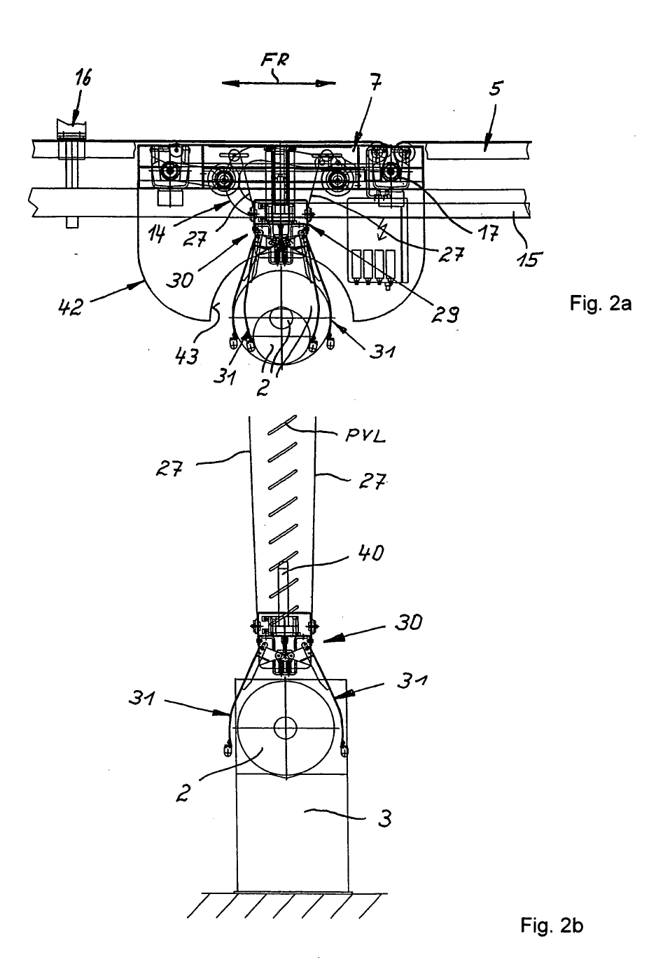

The transport apparatus 4 for removal of bobbins 2 is shown only schematically in FIG. 1 but illustrated in more detail in FIGS. 2 to 6.

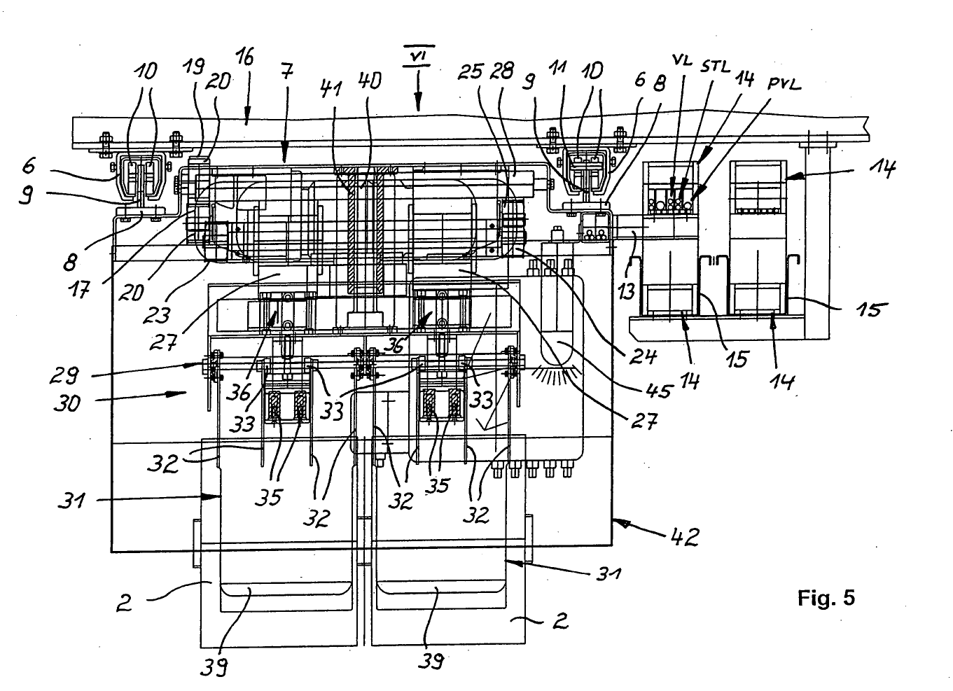

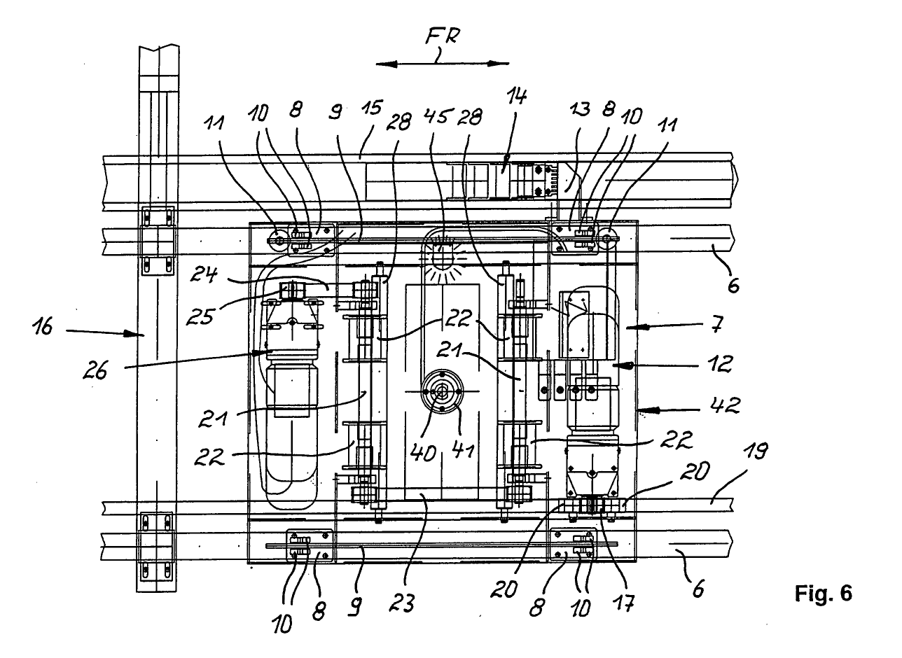

The transport apparatus 4 includes a traveling unit 7 which is suspended from an overhead track 5 for movement along the track 5 in a travel direction FR. The track 5 is comprised of two rails 6 (FIG. 5) which have a C-shaped cross section and are open in downward direction. Secured to the traveling unit 7 are mounts 8 with upwardly directed elongate panels 9 (FIGS. 5 and 6). These panels 9 carry on both sides running rollers 10 which rotate about horizontal axes and are supported on the inside of the confronting horizontal portions of the rails 6. Arranged anteriorly of the running rollers 10 on one of the panels 9 are support rollers 11, which rotate about vertical axes and roll along on the inside of the vertical portions of the rails 6.

The traveling unit 7 is self-propelled and includes an electric motor 12 (FIG. 6) having a longitudinal axis which extends transversely to the travel direction FR. The electric motor 12 is connected in a manner not shown in detail by a supply line with a connection 13 on the traveling unit 7. The connection 13 is connected with an energy chain 14 of plates (FIGS. 2-6). The energy chain 14 can drop in an upwardly open U-shaped trough 15 and has an arcuate configuration starting from the traveling unit 7. The trough 15 extends hereby in parallel relationship next to the track 5 and is supported by a carrier frame 16 which also supports the track 5. As illustrated in FIG. 5, when two traveling units 7 are moved along the track 5, two energy chains 15 are provided and can drop in two troughs 15.

The supply line to the electric motor 12 thus extends via the connection 13 and the energy chain 14 to a control unit which is not shown in detail and located at one end of the track 5.

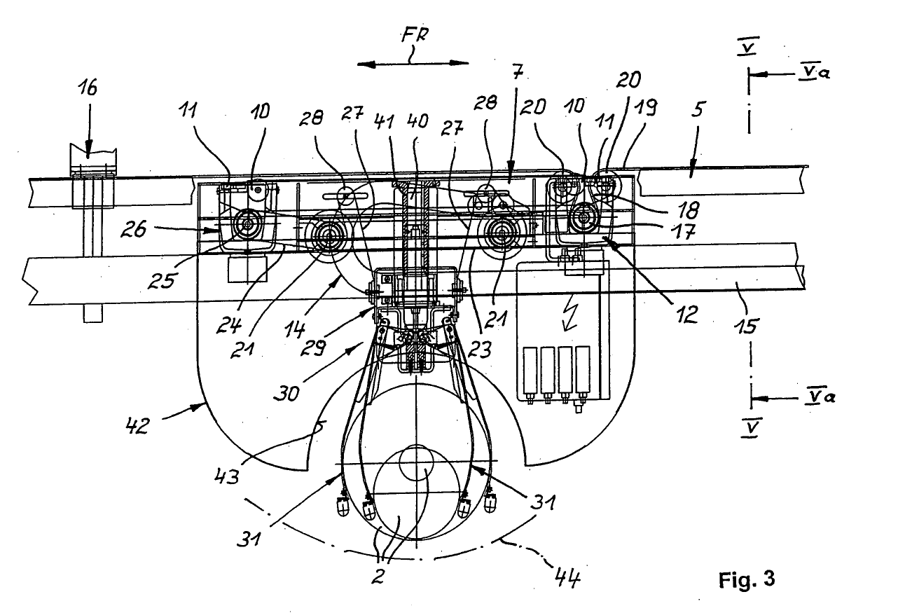

The electric motor 12 includes a driving roller 17 in the form of a toothed roller which engages form-fittingly and force-lockingly an D-shaped loop 18 (FIG. 3) of a toothed belt 19. The Ω-shaped loop 18 is secured along the track 5 and moves conjointly with the traveling unit 7. The toothed belt 19 is hereby guided above the driving roller 17 about two deflection rollers 20 (FIGS. 2, 3, 5 and 6).

A control line for activating the electric motor 12 also extends via the energy chain 14 between the electric motor 12 and the control unit, located on one end of the track 4.

The traveling unit 7 further includes two winding shafts 21 which are disposed in spaced-apart relationship and are each provided with two winding drums 22 in longitudinal offset relationship (FIGS. 3-6). The winding shafts 21 extend transversely to the travel direction FR. Both winding shafts 21 are connected on one end to one another by a toothed belt 23 for synchronous rotation. The other end of one winding shaft 21 (the left winding shaft 21 in FIG. 6) is connected via a toothed belt 24 to an output roller 25 of a further electric motor 26 for operating the winding shafts 21. The electric motor 26 is also operatively connected via supply and control lines with the control unit. The supply and control lines are routed via the connection 13 and the energy chain 14 to the control unit. FIG. 5 shows in general the designation of the supply lines with reference character VL and the designation of the control lines with reference characters STL.

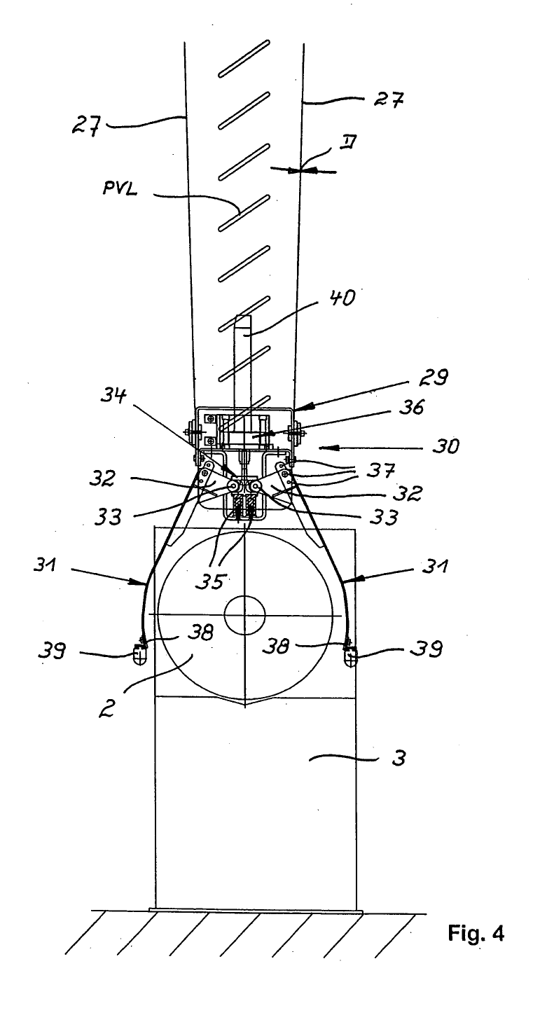

The winding drums 22 are provided to wind and unwind a hoisting device 27 in the form of flat belts. The flat belts 27 are significantly smaller in thickness D than in width B, as shown in FIGS. 1 and 4, and are routed from the winding drums 22 via two deflection drums 28 which are disposed above the winding shafts 21 and adjustably mounted in longitudinal direction of the traveling unit 7.

The flat belts 27 have ends which are distal to the winding drums 22 and secured laterally of a gripper frame 29 of a gripping unit 30. The gripper frame 29 is constructed to provide a pivoting support of four gripper arms 31 which have an arcuate and flat configuration and are coupled to adjustment bars 32 (FIGS. 4 and 5). Operatively connected to the adjustment bars 32 are guide rollers 33 which are movable in horizontal direction in two vertical forced guides 34. The guides 34 are urged upwardly by mechanical springs 35 in the form of spring assemblies with helical compression springs. Pneumatic cylinders 36, when operated, are able to push the guides 34 downwards in opposition to the springs 35.

The supply lines PVL to both pneumatic cylinders 36 between respectively two confronting gripper arms 31 are routed in helical configuration between the flat belts 27 from the traveling unit 7 to the gripping device 30 (FIGS. 2 and 4). The supply lines PVL as well as the electric supply and control lines VL, STL are guided on the traveling unit 7 via the connection 13 and the energy chain 14 to the control unit. FIG. 5 also indicates the pneumatic supply lines PVL.

As shown in particular in FIG. 4, the gripper arms 31 can be pivoted into a total of three distinct positions to allow adjustment of the gripping device 30 to different diameters of bobbins 2. FIG. 3 shows by way of example the gripping device 30 in two different pivot positions.

Disposed along the free lower ends of the gripper arms 31 are switching or safety strips 39 having air chambers which are sealed off to the outside and include electric sensors (FIGS. 4 and 5). The switching strips 39 become operational as soon as a contact, for example with an operator, is registered to trigger an immediate movement of the gripping device 30 into the up position and into the traveling unit 7 (FIGS. 2a, 3). As an alternative, it is also possible to provide electronic bumpers as protection devices along the free lower end of the gripper arms 31, as disclosed e.g. in German Pat. No. DE 199 37 731 C1 to which reference is made.

Extending upwards in mid-section from the gripper frame 29 is a centering mandrel 40 which is received in a sleeve 41 of the traveling unit 7. When occupying the up position, as shown in FIG. 3, the gripping device 30 is securely fixed to the traveling unit 7 via the centering mandrel 40 and the sleeve 41.

The entire traveling unit 7 is enveloped by a dome 42 which has a downwardly open concave opening 43 for receiving the gripping device 30. As shown in FIG. 3, the dome 42 may further be provided with a protective guard 44 which can move underneath the gripping device 30 and is intended to catch a bobbin 2 in the event of a malfunction of the gripping device 30. The guard 44 may be constructed in such a manner as to be swingable or shiftable in relation to the dome 42.

When one or more bobbins 2 are readied by a winding device 1, the control unit generates a signal to move the traveling unit 7 to the respective winding device 1. During travel, the gripping device 30 occupies the up position, as shown in FIGS. 2a, 3 and 5. Once the traveling unit 7 reaches the destination near the winding device 1, the gripping device 30 is lowered, and the gripper arms 31 embrace the bobbins 2 about the circumference like jaws, as shown in FIGS. 2b and 4. After having grabbed the bobbins 2, the gripping device 30 is moved into the up position again, and the traveling unit 7 moves to the desired destination where the bobbins 2 are then deposited for further processing.

As shown in FIGS. 5 and 6, the traveling unit 7 may further have a signaling lamp 45 that can be coupled with an acoustic signal.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. Apparatus for removing a bobbin deposited by a bobbin winding device, comprising:
a track extending anteriorly of a plurality of bobbin winding devices;
a traveling unit suspended from the track and movable along the track in a travel direction, said traveling unit including a drive comprised of an electric motor and one driving roller rolling along the track at least indirectly;
a gripping device having a gripper frame, at least two gripper arms connected to the frame for grabbing a bobbin in a jaw-like manner, a mechanical spring assembly for urging the gripper arms against a surface of the bobbin, and a release mechanism operable to release the gripper arms from the surface of the bobbin;
a motor-driven hoisting device connecting the gripping device to the traveling unit and constructed to move the gripping device between an up position and a down position, wherein the gripping device is centered in the traveling unit, when assuming the up position; and
flexible supply lines feeding power to the traveling unit and the gripping device and extending between one end of the track and a connection of the traveling unit.

2. The apparatus of claim 1, wherein the track has two rails constructed of C-shaped cross section and open downwardly for guiding the traveling unit.

3. The apparatus of claim 1, wherein the driving roller is configured in the form of a toothed roller, said drive including a toothed belt securely mounted along the track and constructed to describe an omega-shaped loop which moves with the traveling unit, said tooted roller engaging the toothed belt in a form-fitting or force-locking manner.

4. The apparatus of claim 1, wherein the hoisting device includes at least two hoisting members, said supply lines for feeding power to the gripping device extending in the form of a helix between the traveling unit and the gripper frame and between the at least two hoisting members.

5. The apparatus of claim 4, wherein the hoisting members are each constructed in the form of a flat belt having broad sides defining planes which extend transversely to the travel direction of the traveling unit.

6. The apparatus of claim 5, wherein the flat belt is made of a material selected from the group consisting of plastic, textile, and fiber combinations of plastic and textile.

7. The apparatus of claim 1, wherein the release mechanism is constructed as a pneumatic cylinder for disengaging the gripper arms from the bobbin.

8. The apparatus of claim 1, wherein the release mechanism is constructed as electrically operated linear drive for disengaging the gripper arms from the bobbin.

9. The apparatus of claim 1, wherein the mechanical spring assembly includes helical compression springs disposed in tetragonal configuration.

10. The apparatus of claim 1, wherein the gripper arms have an arcuate flat configuration, said gripping device having adjustment bars for connection to the gripper arms in one-to-one correspondence, said adjustment bars operatively connected to guide rollers for horizontal movement and engagement in a vertically adjustable forced guidance, which is acted upon by the spring assembly in upward direction and by the release mechanism in downward direction.

11. The apparatus of claim 1, wherein the gripper arms are constructed for pivoting in several positions.

12. The apparatus of claim 1, wherein each gripper arm has a free lower end, and further comprising a switching strip having an electric sensor and air chambers which are sealed off to the outside, said switching strip disposed along the free lower end of the gripper arm.

13. The apparatus of claim 1, wherein each gripper arm has a free lower end, and further comprising an electronic bumper provided along the free lower end of the gripper arm.

14. The apparatus of claim 5, wherein the flat belt has a lower end secured laterally to the gripper frame.

15. The apparatus of claim 1, wherein the hoisting device includes further hoisting members secured to an end surface of the gripper frame.

16. The apparatus of claim 5, wherein the flat belts interact with winding drums in one-to-one correspondence, said traveling unit including an electric motor for synchronous operation of the winding drums.

17. The apparatus of claim 1, wherein the gripper frame includes an upwardly extending centering mandrel, said traveling unit having a sleeve for receiving the centering mandrel.

18. The apparatus of claim 1, further comprising a energy chain of plates extending next to the track, said supply lines for feeding power to the traveling unit being embedded in the energy chain.

19. The apparatus of claim 18, further comprising an upwardly open U-shaped trough for receiving the energy chain.

20. The apparatus of claim 1, further comprising a dome for enveloping the traveling unit, said dome having a downwardly open concave opening for receiving the gripping device.

21. The apparatus of claim 1, further comprising a protective guard associated to the traveling unit and disposed for movement below the gripping device.

22. Apparatus for removing a bobbin, comprising:
a track;
a self-propelled traveling unit suspended from and movable along the track;
a spring-biased gripping device for securely grabbing a bobbin by a spring force,
a release mechanism operable to release the gripper arms from the bobbin in opposition to the spring force;
a hoisting device connecting the gripping device to the traveling unit and constructed to move the gripping device between an up position, in which the gripping device is received, at least partially, in a space of the traveling unit, and a down position, in which the gripping device is intended to grab a bobbin; and
flexible supply lines feeding power to the traveling unit and the gripping device.
